(19) United States
(12) Patent Application Publication
(10) Pub. No.: US 2008/0018147 A1
(43) Pub. Date: Jan. 24, 2008

(54) Contoured bicycle saddle and method of manufacturing

(76) Inventor: David Ybarrola, San Diego, CA (US)

Correspondence Address: GARY L. EASTMAN, EASTMAN & ASSOCIATES, 707 BROADWAY STREET, SUITE 1800, SAN DIEGO, CA, 92101, US

(21) Appl. No.: 11/809,211

(22) Filed: May 30, 2007

Related U.S. Application Data
(60) Provisional application No. 60/808,911, filed on May 30, 2006.
(60) Provisional application No. 60/810,672, filed on Jun. 2, 2006.

(51) Int. Cl. B62J 1/02; B29C 44/18; B29D 31/502

(52) U.S. Cl. 297/214; 264/299; 264/41; 297/215.16

(57) ABSTRACT

A contoured bicycle saddle includes a saddle shell formed with an insertable seat panel that may be custom formed to fit a particular rider's anatomical features. The rider's anatomical features are molded in a saddle shell fixture, a seat panel is fabricated from the molded features, and the seat panel is permanently inserted into the saddle shell. The saddle shell, having the inserted seat panel, may then be covered with a saddle cover or pad as is known in the art. The saddle shell is formed from a high-strength, light-weight polycarbonate resin that is equipped with standard saddle-mounting hardware for easy installation on a standard bicycle seat post.

### RELATED APPLICATIONS

This application claims benefit of the filing dates of co-pending U.S. Provisional Patent Applications Ser. Nos. 60/808,911 filed May 30, 2006, and 60/810,672 filed Jun. 2, 2006.

### FIELD OF THE INVENTION

The present invention relates generally to bicycle saddles. The present invention is more particularly, though not exclusively, related to custom contoured bicycle saddles having personalized contours for enhanced comfort and improved wear, and the apparatus for manufacturing the custom contoured bicycle saddles.

### BACKGROUND OF THE INVENTION

Bicycles have been around for over a century. Over that time, bicycle seats have evolved from chair-like structures of the late 1800s to more streamlined, light-weight racing saddles. While there is a tendency to minimize weight and improve the aerodynamic characteristics of bicycle saddles, these features have to be balanced against the comfort of the saddle. The lack of comfort is a key issue for endurance bicycle riders which may be seated on bicycle saddles for several hours at a time. For instance, a “century” ride is 100 mile trek, often ridden in competition with others, where even the fastest rider time will often exceed five (5) hours.

In an effort to minimize weight of a bicycle, the saddles are often made of lightweight polymer resin shells which may be covered by a thin padding. This padding does little to ease the discomfort for riders on long rides. This padding also provides different benefits for different riders due to their physiological differences and body shapes.

In addition to the saddle covers, some riders use gel-filled saddle pads, however, these are cumbersome and often provide some unwanted movement between the rider and the saddle. Some riders even wear padded riding shorts, which include gel pads located on the pants to provide cushion between the rider and the saddle.

In light of the above, it would be advantageous to provide a bicycle saddle that provides an increased level of comfort while simultaneously minimizing weight and aerodynamic drag on a bicycle. It is further advantageous to provide a bicycle saddle that may be customized for each individual rider to provide a light-weight saddle that is also comfortable for even the longest ride.

### SUMMARY OF THE INVENTION

The contoured bicycle saddle of the present invention includes a saddle shell formed with an insertable seat panel that may be custom formed to fit a particular rider's anatomical features. The rider's anatomical features are molded in a saddle shell fixture, a seat panel is fabricated from the molded features, and then permanently inserted into the saddle shell. The saddle shell, having the inserted seat panel, may then be covered with a saddle cover or pad as is known in the art.

The saddle shell is formed from a high-strength, light-weight polycarbonate resin that is equipped with standard saddle-mounting hardware for easy installation on a standard bicycle seat post.

### BRIEF DESCRIPTION OF THE DRAWINGS

The nature, objects, and advantages of the present invention will become more apparent to those skilled in the art after considering the following detailed description in connection with the accompanying drawings, in which like reference numerals designate like parts throughout, and wherein:

FIG. 1 is a perspective view of the saddle shell showing the seat formed with a panel receiver having an insert rim to receive a seat panel to provide a seating surface;

FIG. 2 is a side view of the contoured bicycle saddle of the present invention showing a custom formed seating panel positioned above the saddle shell and poised for insertion into the panel receiver;

FIG. 3 is a top view of the contoured bicycle saddle of the present invention showing the seat formed with a panel receiver with an insert rim extending around the inside edge;

FIG. 4 is a front view of the contoured bicycle saddle of the present invention showing the mounting hardware for attaching the seat to a bicycle seat post, and showing the location of the insert rim for receiving the seat panel;

FIG. 5 is a back view of the contoured bicycle saddle of the present invention showing the three-point mounting hardware for attaching the saddle to a bicycle seat post, and showing the curvature of the saddle;

FIG. 6 is a perspective view of a contoured bicycle saddle shell fixture of the present invention showing the saddle surface and a mold well that is formed to receive a moldable material that may be used for receiving an impression of a bicycle rider's anatomical features;

FIG. 7 is a side view of a contoured bicycle saddle shell fixture of the present invention having moldable material (shown in dashed lines) in the mold well that may be used to receive the impression (shown in dotted lines) of a bicycle rider;

FIG. 8 is a top view of the contoured bicycle saddle shell fixture of the present invention showing the insert rim formed along the internal rim of the mold well;

FIG. 9 is a front view of the contoured bicycle saddle shell fixture of the present invention showing the three-point mounting hardware for installation on a bicycle seat post, and showing the mold well for receiving the moldable material for taking an impression of a rider's anatomical features;

FIG. 10 is a back view of the contoured bicycle saddle shell fixture of the present invention showing the mold well and the mounting hardware;

FIG. 11 is a bottom view of the contoured bicycle saddle shell fixture of the present invention showing the mounting hardware and overall curvature of the saddle;

FIG. 12A-C is a series of side view showing the manufacturing of a seating panel of the present invention including the molding of the rider's anatomical features on the Fixture of FIG. 6, and the insertion of the seating panel on the shell of FIG. 1;

FIG. 13A-C is a series of side view showing the over-molding of the surface of the shell with an over-molded cushion or saddle padding;

FIG. 13D is a perspective view of a mold used to mold the saddle padding over the finished saddle shell;

FIG. 14A is a cross sectional view of the finished saddle shell inserted into the mold, and the resulting molded pad;

FIG. 14B is a perspective view of the contoured bicycle saddle of the present invention, showing the outer shape of the final product with padding on top of the shell; and

FIG. 15 is a cross sectional view of the contoured bicycle saddle of the present invention, showing a finished saddle with thicker padding areas resulting from the over-molding, and a final covering over the shell.

### DETAILED DESCRIPTION OF A PREFERRED EMBODIMENT

### Saddle Shell

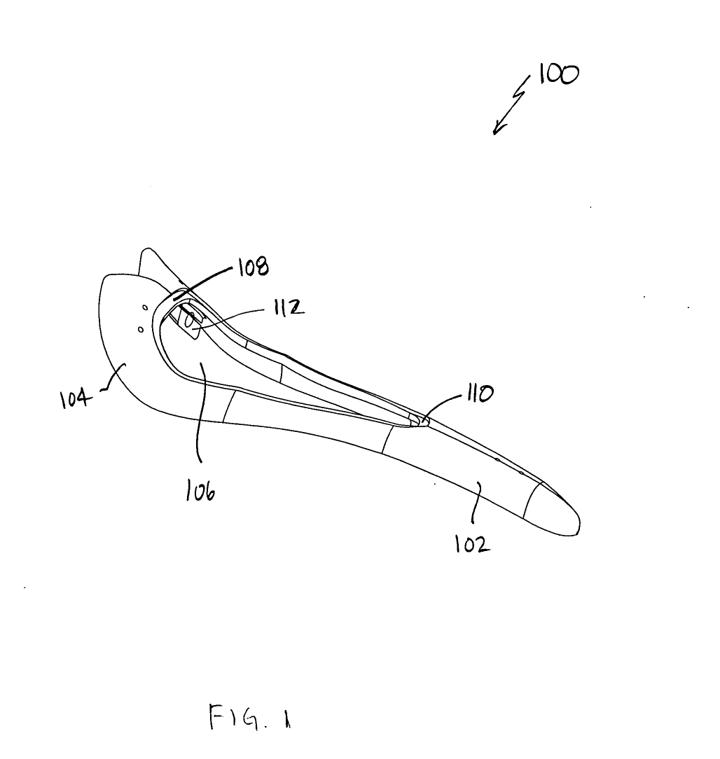

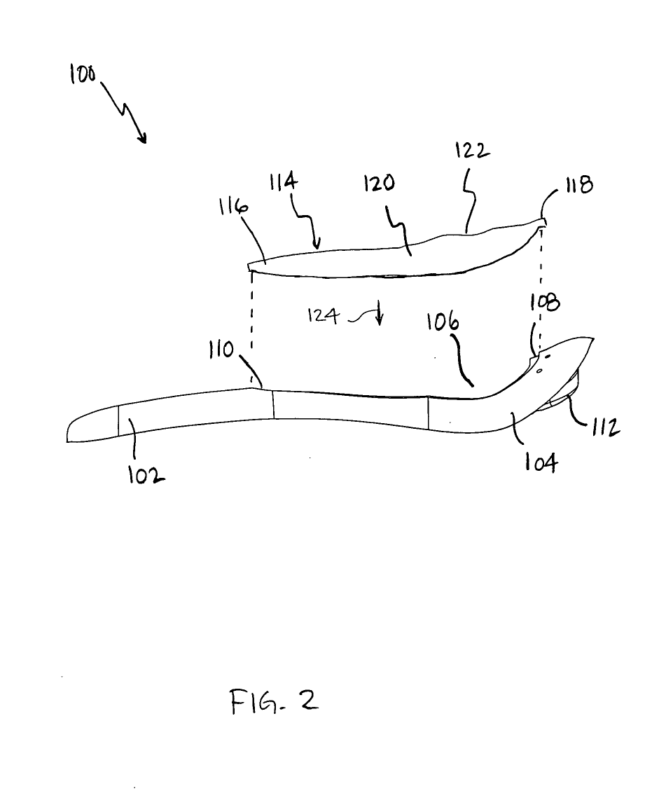

Referring initially to FIG. 1, a perspective view of the saddle shell is shown and generally designated 100. Saddle shell 100 includes a seat 102 formed having a seating surface 104 formed with a panel receiver 106. The panel receiver, and cooperating seating panel 114 (not shown this Figure) will be more thoroughly described in conjunction with FIG. 2. An insert rim or receiver insert rim 108 is formed along the perimeter of panel receiver 106 and provides a stop for the accurate placement of a custom formed seat panel to provide a seating surface on seat 100.

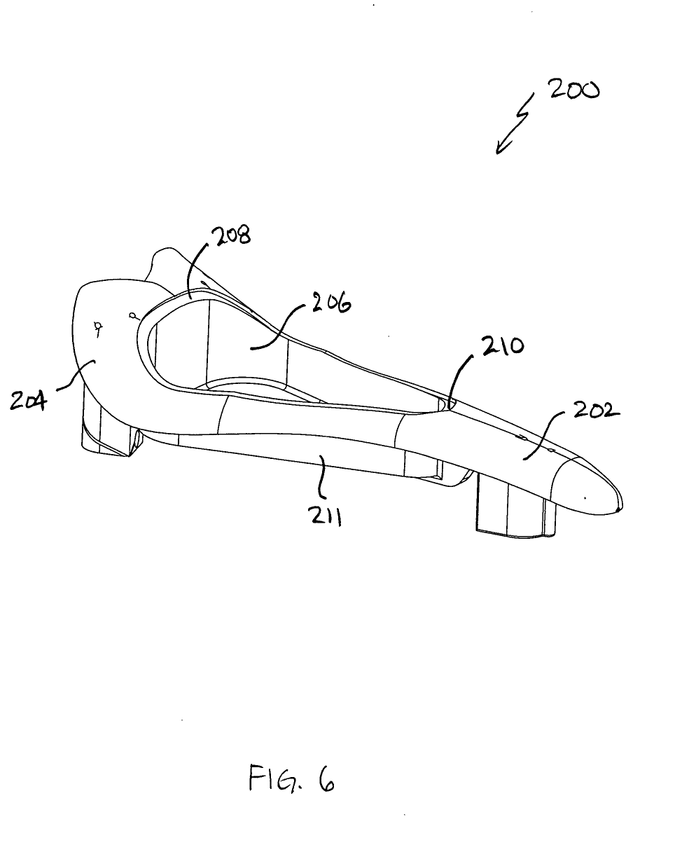

FIG. 2 is a side view of the contoured bicycle saddle 100 of the present invention showing a custom formed seating panel 114 positioned above the saddle shell 102 and poised for insertion into the panel receiver 106. Seating panel 114 has a front 116 and a rear 118 which are sized to be received in the panel receiver 106 and supported by rim 110 and 108, respectively. Seating panel 114 is formed with curvatures 120 and 122 which, as will be described in conjunction with FIGS. 6-11, have been formed to correspond to the anatomical features of a particular bicycle rider.

Once the seating panel 114 has been formed, the panel 114 is positioned above the panel receiver 106 and inserted in direction 124 so that the front 116 and rear 118 sit firmly on insert rim 110 and 108 and secured in place. In a preferred embodiment, the seating panel 114 may be a fiberglass epoxy resin woven panel cured to correspond to the anatomical features of a rider. It is to be appreciated that this material is merely exemplary of a preferred embodiment of the present invention, and that other suitable materials may be used for forming the seating panel 114 without departing from the spirit of the present invention. For instance, seating panel 114 may be of any type of epoxy or other resin (polyester resin) composite with a reinforced fiber. A preferred embodiment would include a carbon fiber with epoxy resin, and could include Kevlar or fiberglass and epoxy resin.

A lower cost alternative embodiment could include a thermoplastic (nylon) sheet approximately 0.125 inches thick that would be heated and vacuum formed over the impression saddle. The sheet of nylon would then be trimmed to fit panel receiver 106.

In a preferred embodiment, seating panel 114 is secured in panel receiver 106 using an epoxy compatible with the composite materials of the saddle 102 and the seating panel 114. For instance, seating panel 114 may be secured in panel receiver 106 using 3M brand DP420, Hysol brand #9340, Araldite brand #2014, and Scotch Weld #9323. It is to be appreciated that other adhesives known in the art may be used.

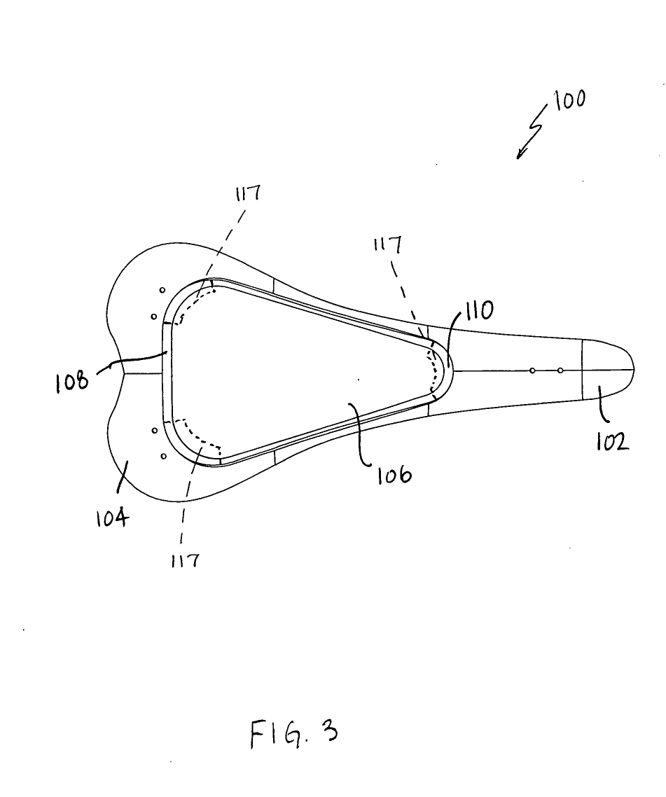

Referring now to FIG. 3, a top view of the contoured bicycle saddle 100 of the present invention is shown. Saddle 100 has a panel receiver 106 symmetrically positioned on the seat 102. The rim 110 and 108 is shown clearly in this view, and extends around the inside edge of the panel receiver 106. It is to be appreciated that while the rim 110 and 108 is shown to extend around the entire perimeter of panel receiver 106, it is possible that rim 110 and 108 may be discontinuous, and may consist of a series of spaced apart tabs 117 (shown in dashed lines) extending into the panel receiver 106 and positioned to receive and support seating panel 114. The panel receiver may, in a preferred embodiment, be only slightly larger than the panel insert itself, and in some applications, no panel receiver may be necessary when the panel insert is formed with the necessary hardware for use in conjunction with a bicycle mounting post.

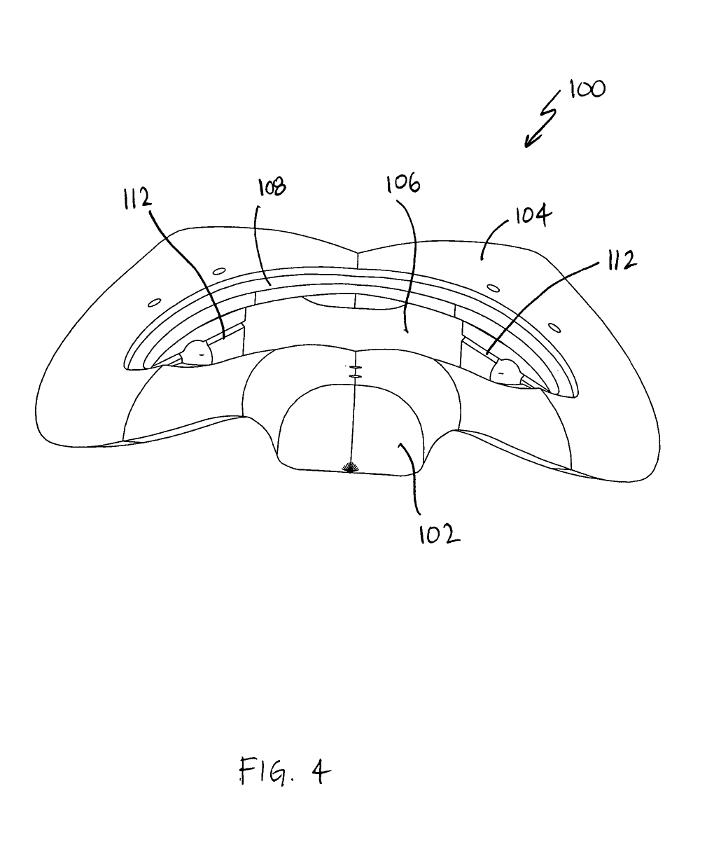

FIG. 4 is a front view of the contoured bicycle saddle 100 of the present invention showing the mounting hardware 112 for attaching the seat 102 to a bicycle seat post (not shown), and showing the location of the panel receiver 106 and the insert rim 108 for receiving the seat panel 114 (not shown). As is known in the art, a saddle rail (not shown) would extend between mounting hardware 112 to facilitate mounting saddle 100 to a bicycle seat post.

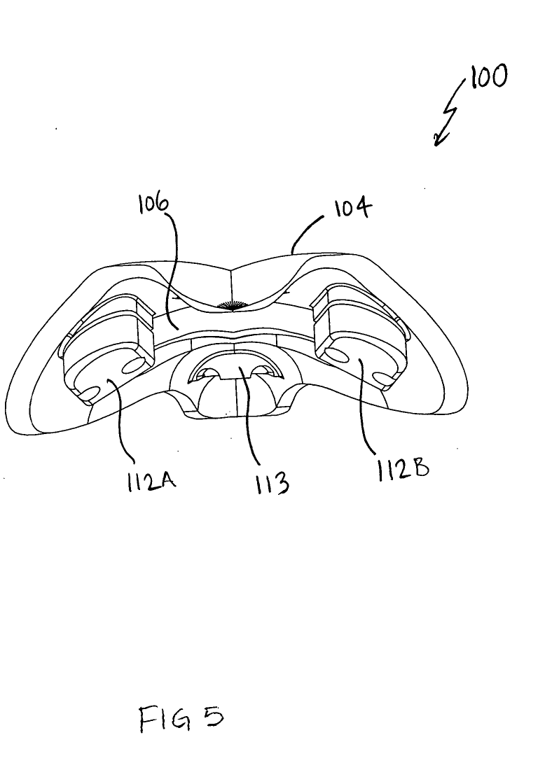

FIG. 5 is a back view of the contoured bicycle saddle 100 of the present invention showing the three-point mounting hardware 112A, 112B and 113 for attaching the saddle 100 to a bicycle seat post, and showing the curvature of the seating surface 104 of the saddle 100.

### Saddle Shell Fixture

Referring now to FIG. 6, a perspective view of a contoured bicycle saddle shell fixture of the present invention is shown and generally designated 200. Fixture 200 includes a saddle 202 having a seating surface 204 and formed with a mold well 206. Mold well 206 includes a basin 211 that is formed to receive a moldable material (not shown this Figure) that may be used for receiving an impression of a bicycle rider's anatomical features. A ridge (or insert rim or well insert rim) 208 and 210 is shown surrounding the mold well 206. It is to be appreciated, however, that ridge 208 and 210 may be omitted from the present embodiment without departing from the scope of the present invention. In such an instance, the mold well 206 would extend upwards to join seating surface 204.

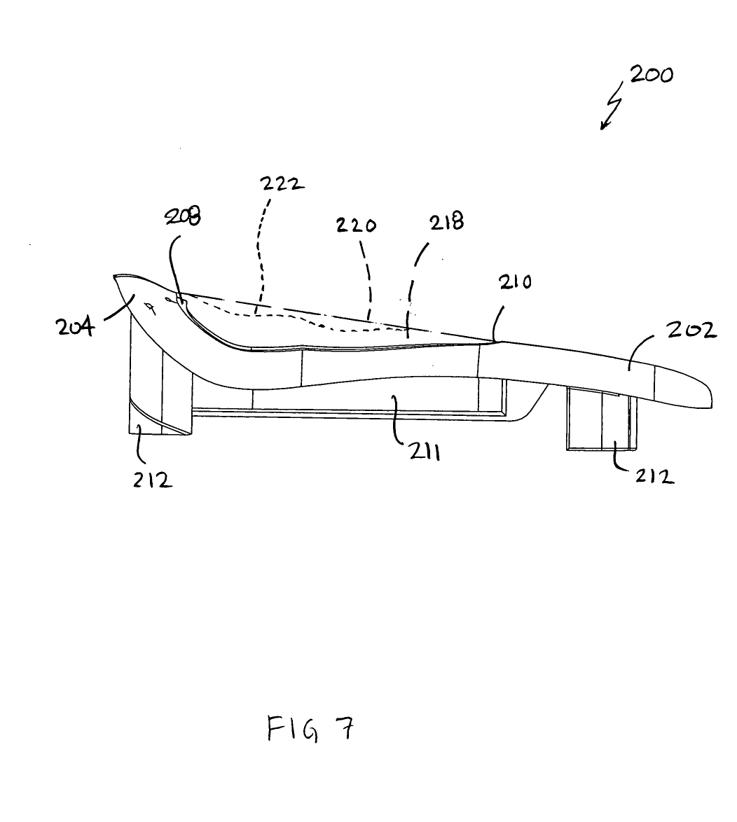

FIG. 7 shows a side view of the contoured bicycle saddle shell fixture 200 of the present invention having a moldable material 218 (shown in dashed lines) in the basin 211 of the mold well 206 that may be used to receive the impression (shown in dotted lines) of a bicycle rider. More specifically, when the moldable material 218 is placed in mold well 206, it has an original surface contour 220 as shown in dashed lines. A rider sits on the seating surface 204 of fixture 200 and the anatomical characteristics of the rider, dependent upon weight, bone structure, etc., compresses the moldable material 218 to form an impression contour 222 as shown in dotted lines. This impression contour 222 corresponds uniquely to that rider's anatomical features.

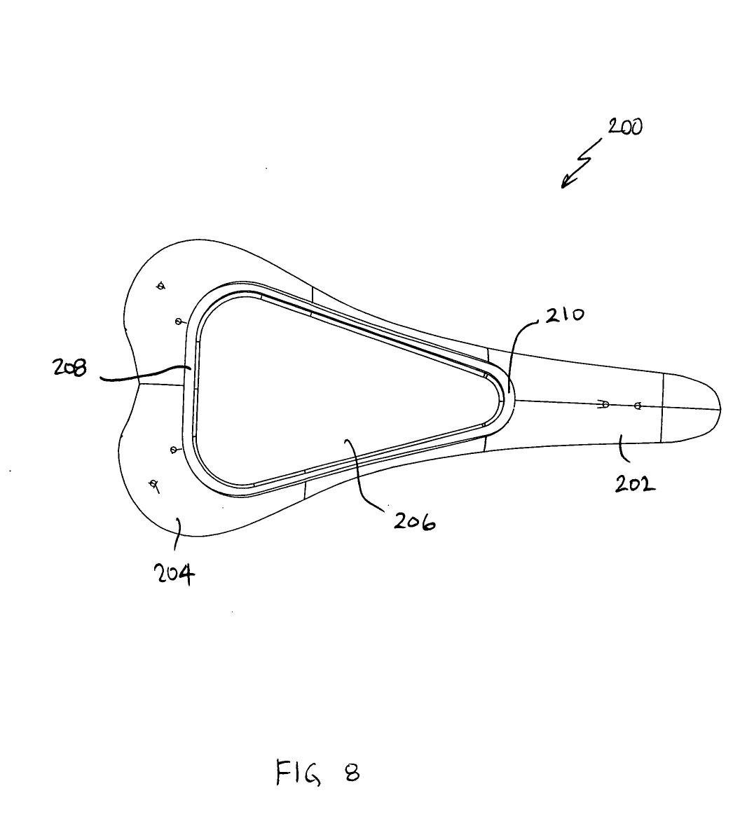

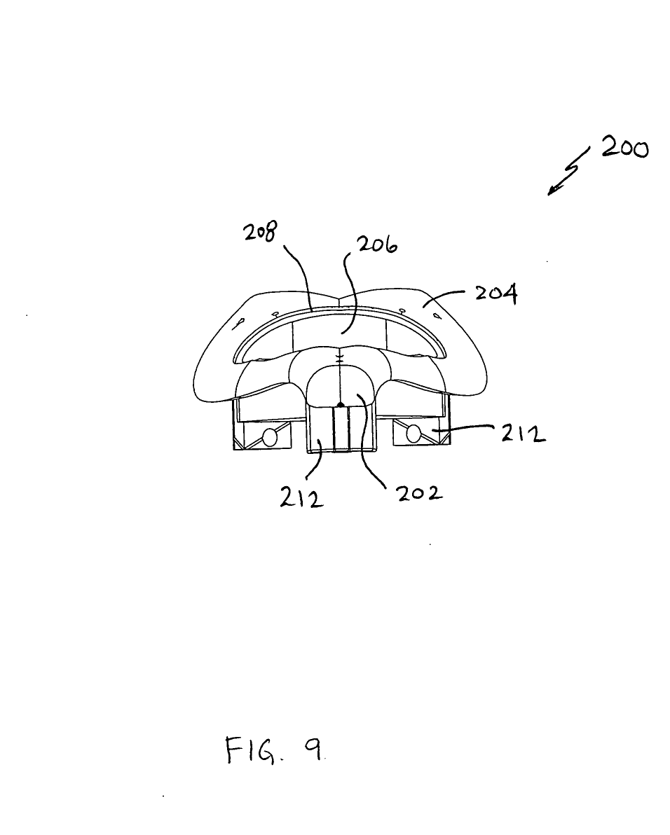

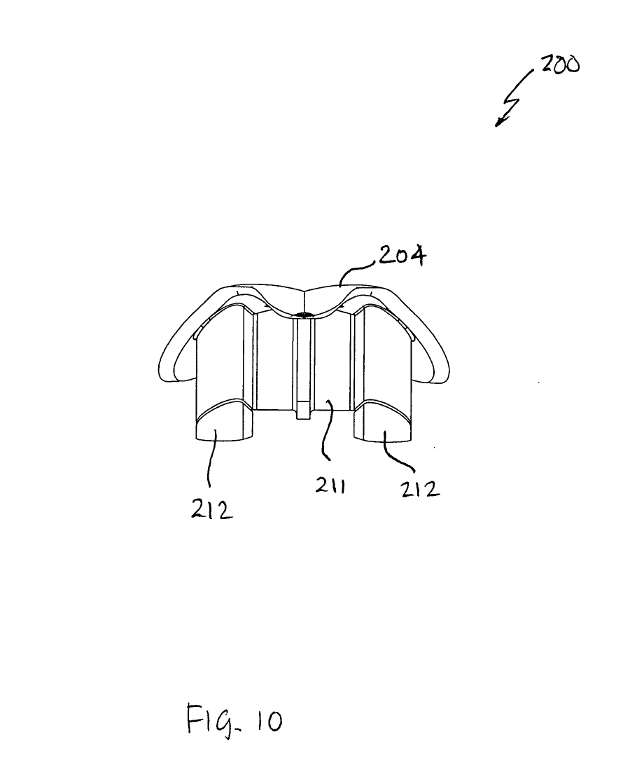

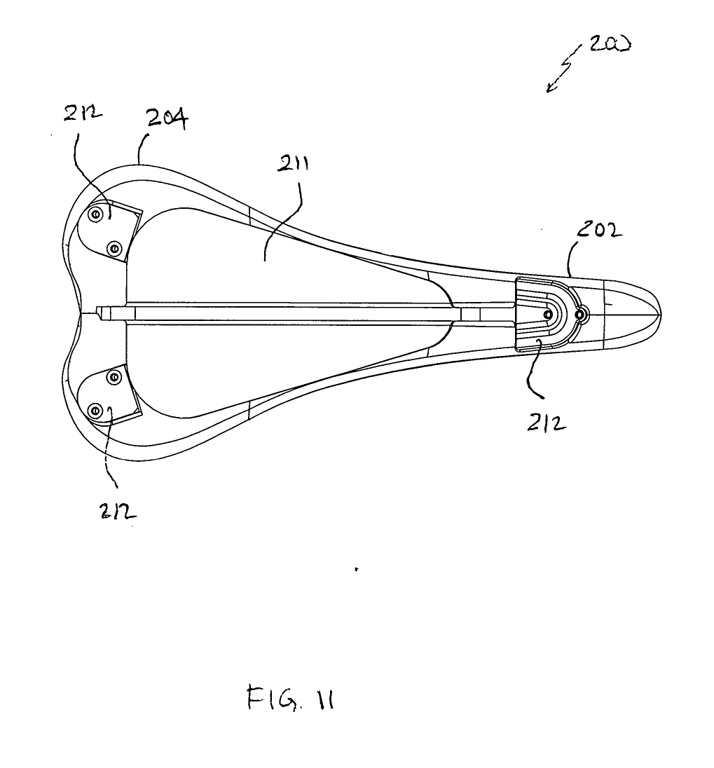

FIG. 8 shows a top view of the contoured bicycle saddle shell fixture 200 of the present invention with the insert rim 208 and 210 formed along the internal rim of the mold well 206. FIG. 9 is a front view of the contoured bicycle saddle shell fixture 200 of the present invention showing the three-point mounting hardware 212 for installation on a bicycle seat post, and showing the mold well 206 for receiving the moldable material 218 (not shown this Figure) for taking an impression of a rider's anatomical features. FIG. 10 is a back view of the contoured bicycle saddle shell fixture 200 of the present invention showing the basin 211 of the mold well 206 and the mounting hardware 212. FIG. 11 is a bottom view of the contoured bicycle saddle shell fixture 200 of the present invention showing the mounting hardware 212 and overall curvature of the saddle 200 and seating surface 204.

### Method of Manufacturing

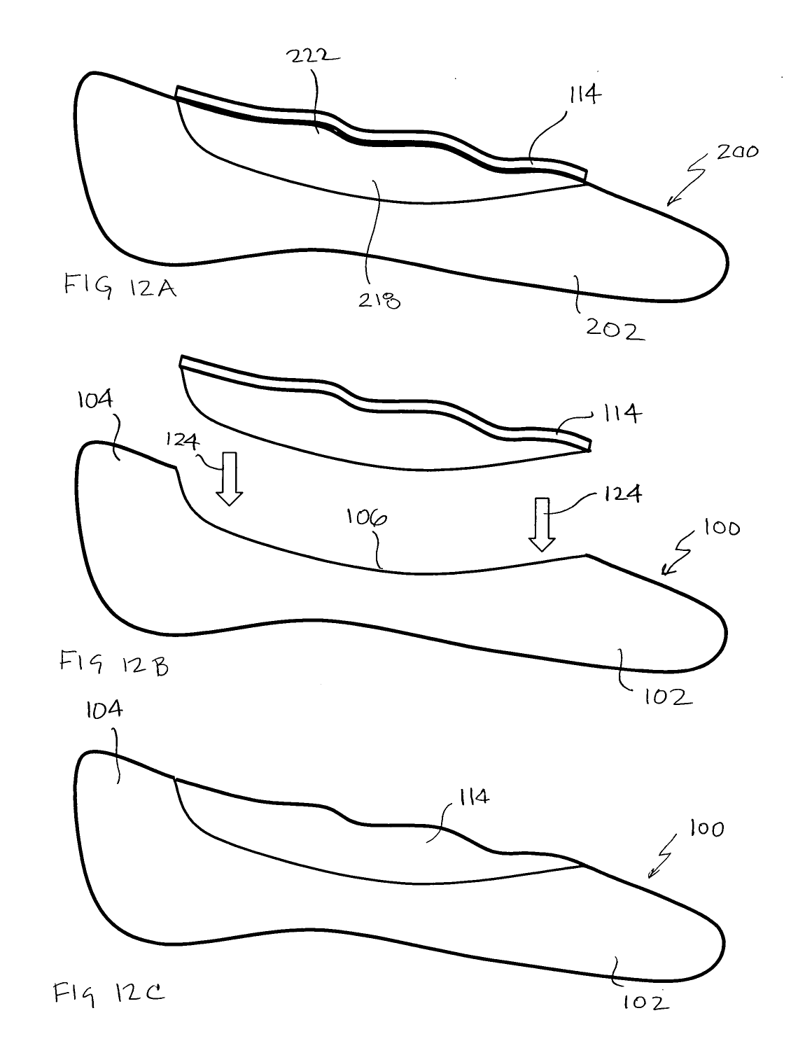

Referring now to FIG. 12A, 12B and 12C, a manufacturing method for the saddle 100 is depicted. Starting with FIG. 12A, the mold well 206 of fixture 200 is loaded with a moldable material 218. A person sits on the fixture 200 to create contours 222 on the surface of the moldable material 218. If necessary, once the contour is formed, the moldable material is allowed to harden.

Once hardened, the moldable material is used as a form for a seat panel 114 which is formed as shown in FIG. 12A. Using the contour 222 of moldable material 218, the exact contour corresponding to the rider's anatomical features is transferred to the seat panel 114. The seat panel 114 is allowed to harden, and then removed from fixture 200. The fixture 200 may be reused by re-loading the mold well 206 with fresh moldable material 218, and a new mold taken for a different rider.

As shown in FIG. 12B, once the seat panel 114 has hardened, the seat panel may be positioned above the panel receiver 106 of shell 100 and inserted in direction 124 so that the seat panel 114 is flush with seating surface 104 of shell 100. The seat panel 114 is then secured in place in shell 100 to form a unitary saddle as shown in FIG. 12C. This unitary saddle may be covered with a saddle cover and installed on a bicycle for use.

The moldable material used in the fixture 200 of the present invention in a preferred embodiment may be any material suitable for receiving an impression. For instance, clay would be suitable for taking a contour shape from a rider's anatomy. Alternatively, a rigid polyurethane foam which does not rebound or recover once deformed may be used. One such foam is available under the tradename “Bio-foam.”

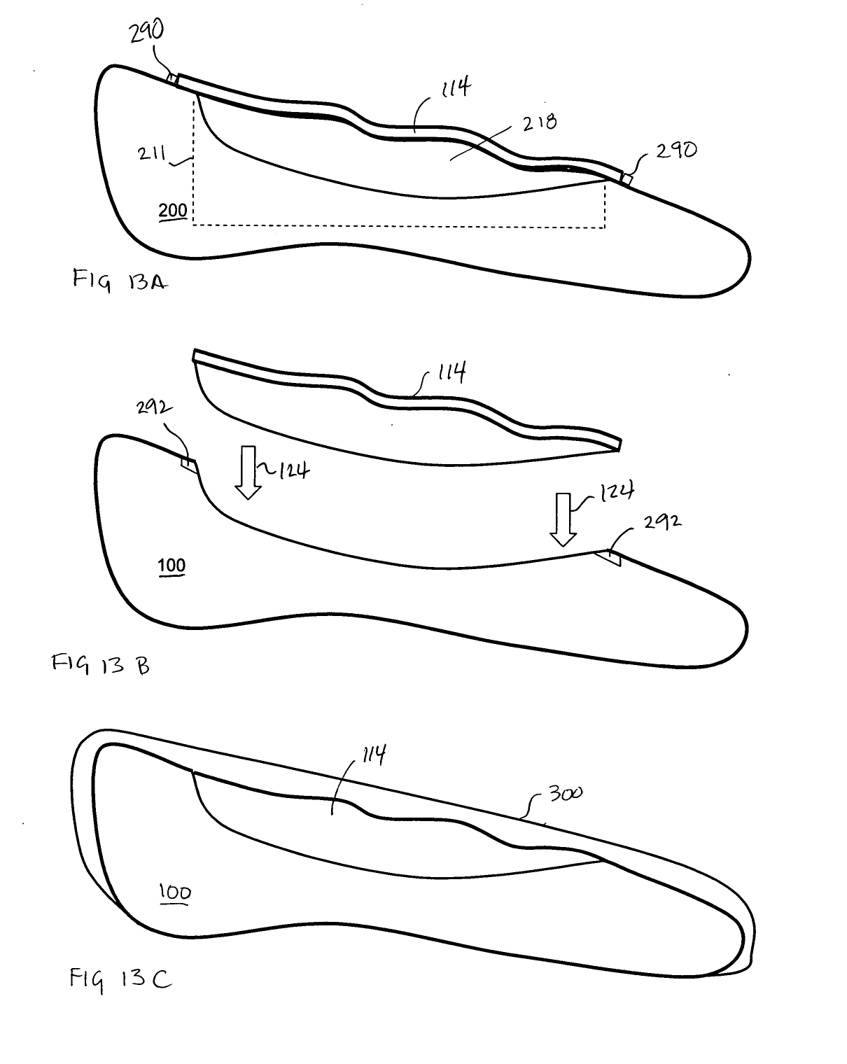

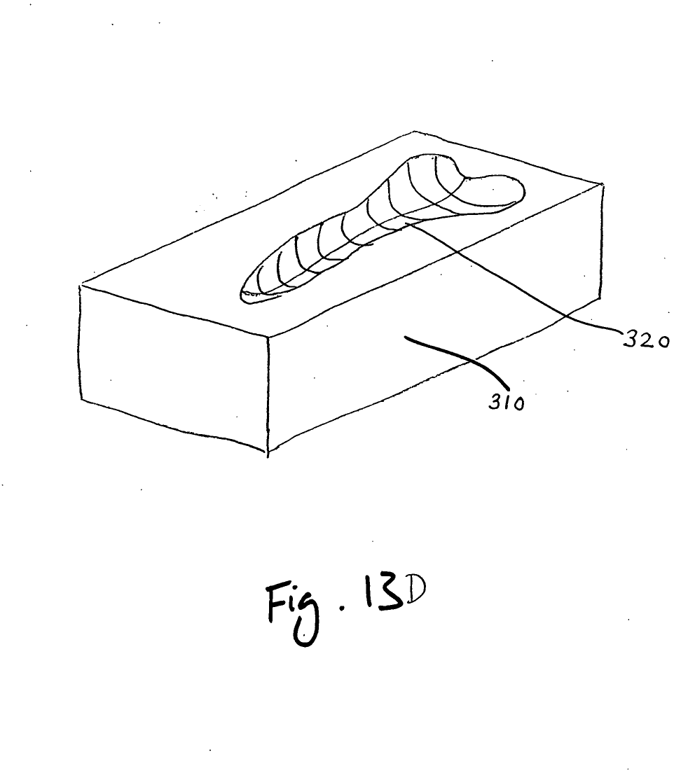

Referring now to FIG. 13A-13C, an alternative method of manufacturing the saddle 100 is shown. In this embodiment, stops 290 are formed to provide a termination location for the panel 114 as it is formed over moldable material 218. In this method, the resulting shape of panel 114 as shown being formed in FIG. 13A, fits snugly within cutouts 292 in saddle 100 as shown being inserted in direction 124.

### Saddle Padding

FIG. 13A shows that, once in position in saddle 100, insert 114 provides a smooth surface which can then be easily covered with an over-molded cushion (or foam padding or foam or padding) 300 which may be polyurethane foam. Over-molded cushion covers the anatomical curvature of the saddle 100. FIG. 13D shows a mold 310 for forming foam padding 300. Once shell 100 is complete with insert 114 glued in place, foam padding 300 can then be applied for even more cushioning and comfort. Alternatively, padding 300 may be omitted if, for example, a very light weight race saddle is desired.

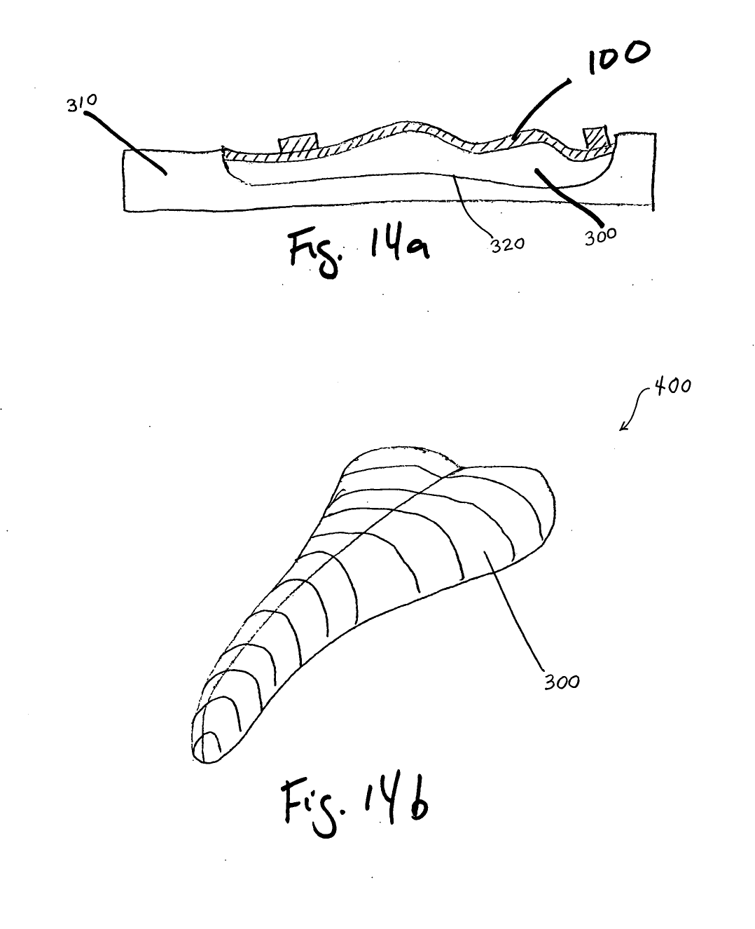

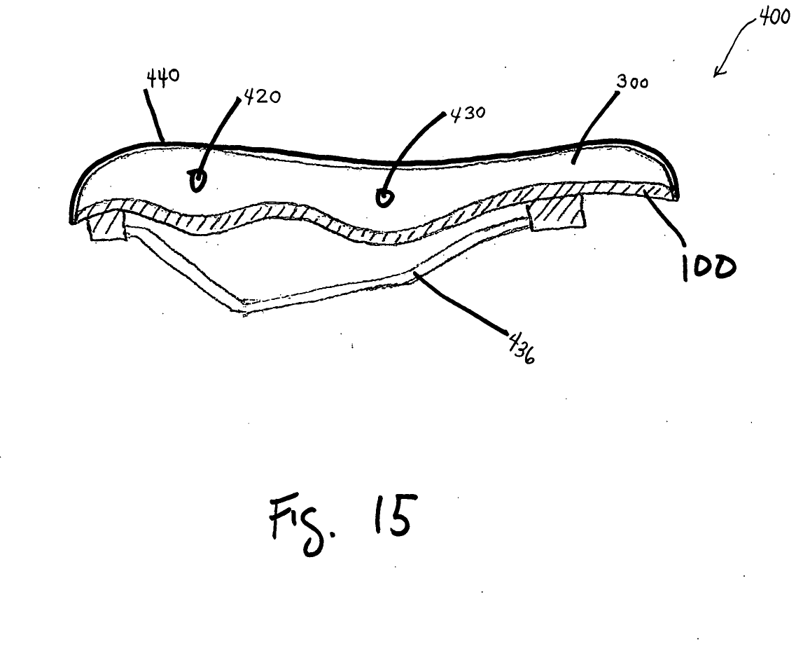

FIG. 14a shows a cross section of mold 310 with shell 100 inserted therein, with a space 320 between mold 310 and shell 100. Foam 300 is then molded over the surface of shell 100 by injecting foam 300 into space 320. The injected foam 300 then solidifies in space 320 to form padding 300, which will determine the overall outer shape of the finished product. Shell 100 with padding 300 is then removed from mold 310.

FIG. 14b is a perspective view of the contoured bicycle saddle of the present invention generally designated 400, after the foam 300 has been molded over the shell 100, showing that saddle 400 looks like a standard bicycle saddle. The surface of saddle 400 has a smooth flowing shape without the irregularities and anatomical depressions of insert 114. The benefit of applying the foam padding 300 in this manner is that the saddle 400 will look like a normal saddle and not have any bumps or depressions that will prevent movement of the rider while using the saddle 400. It also has the benefit of giving the rider the padding 300 only where necessary. Where the rider's body has made an anatomical depression in the shell 100, he will automatically have more padding 300 in that spot. Where the rider did not need extra padding 300 he will not have extra. This will serve to make the saddle 400 light weight and more comfortable than other bicycle saddles.

An alternative method of applying foam 300 is applying a uniform thickness of foam 300 over the entire shell 100. This method would have the foam padding following the contours of shell 100. However, this method does not provide the advantage of giving the rider more padding 300 where the rider's body has made an anatomical depression in the shell 100.

FIG. 15 shows a cross section of the finished contoured bicycle saddle of the present invention generally designated 400, turned right side up, and with a final covering. Areas 420 and 430 are areas that would typically have extra padding to correspond to rider anatomy. FIG. 15 also shows mounting rail 436, and final covering 440 of the saddle 400. Final covering 440 is typically leather, but can also be a leather substitute or any other material of comparable strength.

Once a contoured bicycle saddle made in accordance with the present invention has been completed, a negative mold may be cast from the saddle containing the seat imprint. This negative mold, or casting, may be utilized as is known in the art to make one or more bicycle saddles with each having the identical anatomical contours of the original mold without the need to manufacture multiple inserts from a single mold. Using this method, a bicycle rider may have a single impression taken, and may then have duplicate saddles manufactured in succession using the same casting, or may simply order additional saddles from his or her unique anatomical saddle casting.

While there have been shown what are presently considered to be preferred embodiments of the present invention, it will be apparent to those skilled in the art that various changes and modifications can be made herein without departing from the scope and spirit of the invention.

I claim:

1. A contoured bicycle saddle comprising:
a saddle shell having a seat formed with a seating surface formed with a panel receiver having a perimeter and a receiver insert rim formed along said perimeter; and
a seating panel having a front and a rear, said seating panel formed with one or more curvatures corresponding to anatomical features of a rider, said seating panel received in said panel receiver and supported by said receiver insert rim providing a stop for the placement of said seating panel.

2. A contoured bicycle saddle as in claim 1, wherein:
said seating panel comprises carbon fiber and epoxy resin.

3. A contoured bicycle saddle as in claim 1, wherein:
said seating panel comprises a fiberglass epoxy resin woven panel.

4. A contoured bicycle saddle as in claim 1, wherein:
said seating panel comprises nylon.

5. A contoured bicycle saddle as in claim 1, wherein:
said seating panel is secured in said panel receiver using epoxy.

6. A contoured bicycle saddle as in claim 1, wherein:
said receiver insert rim is discontinuous and comprises a series of spaced apart tabs extending into said panel receiver and positioned to receive and support said seating panel.

7. A contoured bicycle saddle as in claim 1, further comprising:
three-point mounting hardware for attaching said saddle shell to a bicycle seat post.

8. A contoured bicycle saddle as in claim 1, further comprising:
foam padding upon said saddle shell and said seating panel.

9. A contoured bicycle saddle as in claim 8, wherein:
said foam padding comprises polyurethane.

10. A method of manufacturing a contoured bicycle saddle as in claim 1, further comprising:
a saddle cover covering said saddle shell and said seating panel.

11. A contoured bicycle saddle shell fixture comprising:
a saddle having a seating surface and formed with a mold well including a basin formed to receive a moldable material for receiving an impression of anatomical features of a rider.

12. A contoured bicycle saddle shell fixture as in claim 11, wherein:
said mold well has an internal rim and a well insert rim formed along said internal rim.

13. A contoured bicycle saddle shell fixture as in claim 12, further comprising:
three-point mounting hardware for installing said saddle on a bicycle seat post.

14. A method of manufacturing a contoured bicycle saddle comprising the steps of:
providing a moldable material for receiving an impression of anatomical features of a rider;
providing a fixture having a saddle having a seating surface and formed with a mold well including a basin;
placing said moldable material in said mold well; and
seating said rider on said seating surface wherein said anatomical features of said rider at least partially compress said moldable material, wherein said moldable material is formed with an impression contour corresponding to said anatomical features.

15. A method of manufacturing a contoured bicycle saddle as in claim 14, wherein:
said moldable material comprises clay;

16. A method of manufacturing a contoured bicycle saddle as in claim 15, wherein:
said moldable material comprises polyurethane foam;

17. A contoured bicycle saddle shell fixture as in claim 16, wherein:
said mold well has an internal rim and a well insert rim formed along said internal rim.

18. A method of manufacturing a contoured bicycle saddle as in claim 17, further comprising the steps of:
allowing said moldable material to harden;
providing a seat panel;
forming said seat panel on said moldable material, wherein said contour is transferred to said seat panel;
allowing said seat panel to harden; and
removing said seat panel from said moldable material.

19. A method of manufacturing a contoured bicycle saddle as in claim 17, wherein:
said fixture further comprises stops for providing a termination location for said seat panel formed on said moldable material.

20. A method of manufacturing a contoured bicycle saddle as in claim 17, further comprising the steps of:
providing a saddle shell having a seat formed with a seating surface formed with a panel receiver having a perimeter and a receiver insert rim formed along said perimeter;
inserting said seat panel in said panel receiver, wherein said seat panel is substantially flush with said seating surface; and
securing said seat panel in place in said shell to form a unitary saddle.

21. A method of manufacturing a contoured bicycle saddle as in claim 17, wherein:
said securing said seat panel in place in said shell, is done using epoxy.

22. A method of manufacturing a contoured bicycle saddle as in claim 17, further comprising the step of:
covering said unitary saddle with foam padding.

23. A method of manufacturing a contoured bicycle saddle as in claim 17, wherein said step of covering said unitary saddle with foam padding, comprises the steps of:
providing a mold for forming foam padding;
inserting said unitary saddle in said mold, wherein there is a space between said mold and said unitary saddle;
providing a foam for forming a foam padding;
injecting said foam into said space;
allowing said foam to solidify to form a foam padding upon said unitary saddle;
removing said unitary saddle with said foam padding from said mold.

24. A method of manufacturing a contoured bicycle saddle as in claim 17, wherein:
said foam comprises polyurethane.

25. A method of manufacturing a contoured bicycle saddle as in claim 23, further comprising the step of:
covering said unitary saddle with a saddle cover.
